(19) United States
(12) Patent Application Publication
(10) Pub. No.: US 2013/0152904 A1
(43) Pub. Date: Jun. 20, 2013

(54) Turbo Purge Module For Turbocharged Vehicle

(71) Applicant: Continental Automotive Systems, Inc., Auburn Hills, MI (US)

(72) Inventors: David William Balsdon, Chatham (CA); Brian Gordon Woods, Chatham (CA)

(73) Assignee: Continental Automotive Systems, Inc., Auburn Hills, MI (US)

(21) Appl. No.: 13/691,884

(22) Filed: Dec. 3, 2012

Related U.S. Application Data
(60) Provisional application No. 61/577,445, filed on Dec. 19, 2011.

(51) Int. Cl. F02M 27/00

(52) U.S. Cl. CPC F02M 27/00
USPC 123/518

(57) ABSTRACT

A turbo purge module includes a purge valve connected between a vapor collection canister and an intake manifold. A venturi nozzle receives pressurized air from the turbocharger, when the turbocharger is operating, to create a vacuum to draw vapors from the canister through the purge valve to an inlet of the turbocharger and the intake manifold to be purged in the engine. A first check valve prevents pressure from the intake manifold from reaching the canister when the turbocharger is operating. A second check valve prevents vacuum pressure from the intake manifold from communicating with the venturi nozzle when the turbocharger is at idle, with vapor from the canister being drawn through the purge valve and the intake manifold to be purged in the engine. The purge valve, venturi nozzle, first check valve, and second check valve are integrated into a single component.

This application claims the benefit of U.S. Provisional Application No. 61/577,445, filed on Dec. 19, 2011.

### FIELD

This invention relates to vapor management systems of vehicles and, more particularly, to dual operation turbo purge module that creates a vacuum when a turbocharger is used and uses manifold vacuum when the turbocharger is not used.

### BACKGROUND

With reference to FIG. 1, a conventional evaporative vapor management system for a turbocharged vehicle is shown, generally indicated at 10. When the turbocharger 12 is operating, high pressure air (arrow A) from the turbocharger 12 is directed through a venturi nozzle 14 to induce a vacuum (arrows B) that draws hydrocarbons from canister 18 through the electronically operated purge valve 18, to the inlet of the turbocharger 12, through the throttle 20 and intake manifold 22, for purging at the engine (not shown). The canister 18 and fuel tank (not shown) connected therewith is protected from manifold pressure by use of a check valve 22.

With reference to FIG. 2, when the turbocharger 12 is idle, manifold vacuum (arrows C) provides conventional purging through the engine. A check valve 24 prevents the vacuum from reaching the venturi nozzle 14.

The system 10 includes many separate components that are interconnected by various low permeability, flexible hoses requiring hose mounting clips. The individual component connections with hoses can be pressure or vacuum leakage points. Also, the flow in the system 10 is not consistent from application to application.

Thus, there is a need to integrate components of the system 10 to reduce packaging size, to reduce the number of hose connections, to reduce cost, and to reduce flow variability.

### SUMMARY

An object of the invention is to fulfill the need referred to above. In accordance with the principles of an embodiment, this objective is achieved by an evaporative emission management system for a vehicle. The system includes a vapor collection canister constructed and arranged to be connected with a fuel tank to receive hydrocarbon vapors from the fuel tank; an intake manifold for drawing air into an internal combustion engine of the vehicle; a turbocharger connected with the intake manifold to provide pressurized air to the engine; and a single, integral turbo purge module. The module includes a purge valve having an inlet connected to the canister and an outlet connected to the intake manifold; a venturi nozzle constructed and arranged to receive pressurized air from the turbocharger, when the turbocharger is operating, to create a vacuum to draw vapors from the canister through the purge valve to an inlet of the turbocharger and the intake manifold to be purged in the engine; a first check valve to prevent pressure from the intake manifold from reaching the canister when the turbocharger is operating; and a second check valve to prevent vacuum pressure from the intake manifold from communicating with the venturi nozzle when the turbocharger is at idle, with vapor from the canister being drawn through the purge valve and the intake manifold to be purged in the engine.

In accordance with another aspect of an embodiment, a turbo purge module for an emission management system of a turbocharged vehicle is provided. The vehicle includes a vapor collection canister constructed and arranged to be connected with a fuel tank to receive hydrocarbon vapors from the fuel tank; an intake manifold for drawing air into an internal combustion engine of the vehicle; and a turbocharger connected with the intake manifold to provide pressurized air to the engine. The module includes a purge valve having an inlet constructed and arranged to be connected to the vapor collection canister, and an outlet constructed and arranged to be connected to the intake manifold; a venturi nozzle constructed and arranged to receive pressurized air from the turbocharger, when the turbocharger is operating, to create a vacuum to draw vapors from the canister through the purge valve to an inlet of the turbocharger and the intake manifold to be purged in the engine; a first check valve to prevent pressure from the intake manifold from reaching the canister when the turbocharger is operating; and a second check valve to prevent vacuum pressure from the intake manifold from communicating with the venturi nozzle when the turbocharger is at idle, with vapor from the canister being drawn through the purge valve and the intake manifold to be purged in the engine. The purge valve, venturi nozzle, first check valve, and second check valve are integrated into a single component.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, in which:

FIG. 1 is a schematic view of a conventional evaporative vapor management system for a turbocharged vehicle, shown purging hydrocarbons when the turbocharger is operating.

FIG. 2 is a schematic view of the conventional evaporative vapor management system of FIG. 1, shown purging hydrocarbons when the turbocharger is idle.

FIG. 3 is a schematic view of an evaporative vapor management system, showing in schematic view, a turbo purge module provided in accordance with an embodiment.

FIG. 4 is a side view of a turbo purge module of an embodiment.

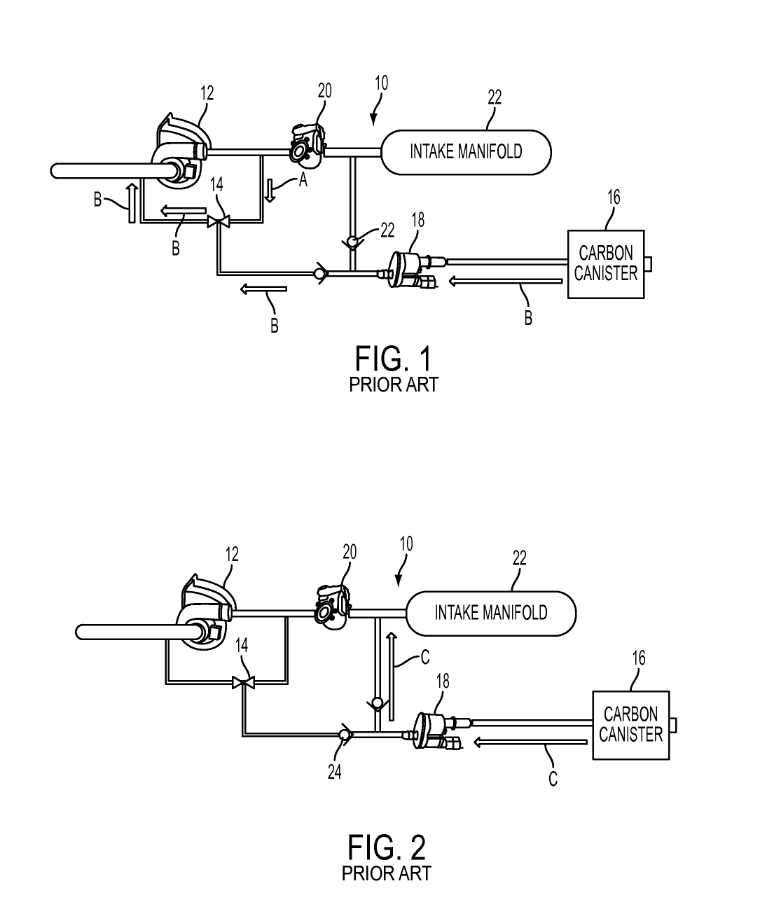

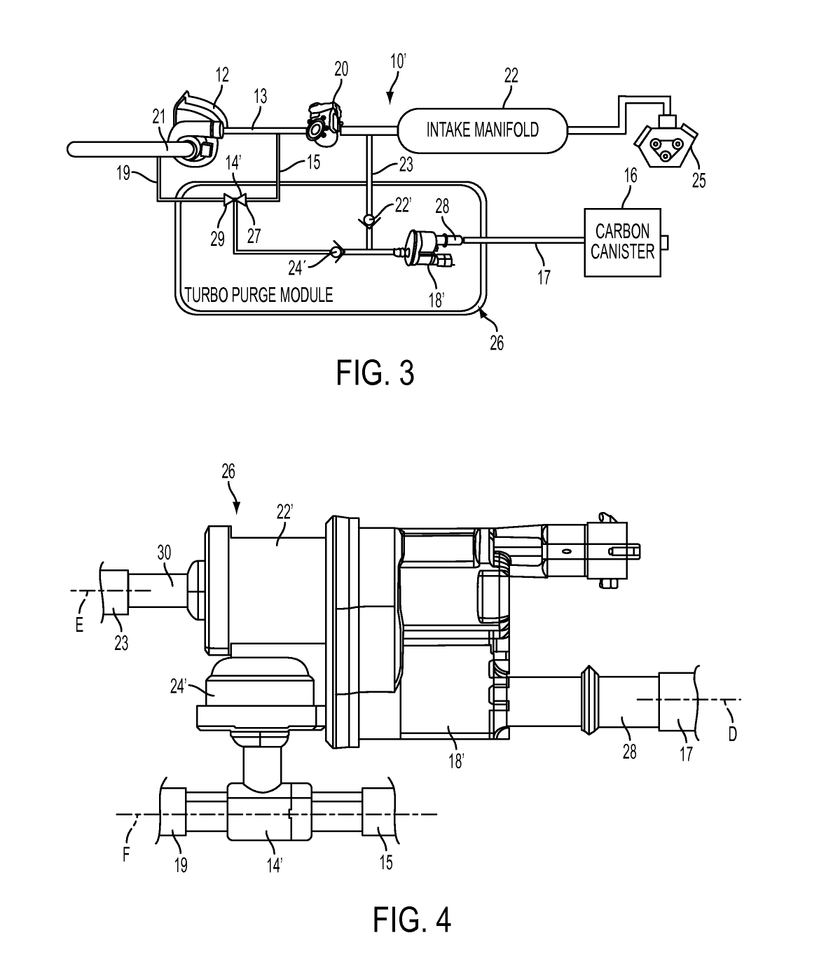

### DETAILED DESCRIPTION OF AN EXEMPLARY EMBODIMENT

Referring to FIG. 1, a schematic view of an evaporative vapor management system is shown, generally indicated at 10′ having a turbo purge module, generally indicated at 26, in accordance with an embodiment. The turbo purge module 26, as shown in FIG. 4, integrates the venturi nozzle 14′, the check valves 22′ and 24′ and the purge valve 18′ into a single component. Thus, the purge valve 18′ is coupled directly (absent any flexible hoses) with the check valves 22′ and 24′, with the venturi nozzle being coupled directly (absent any flexible hose) with the check valve 24′. The canister 16 is constructed and arranged to be connected with a fuel tank to receive hydrocarbon vapors therefrom in the conventional manner.

When the conventional turbocharger 12 is operating, high pressure air from the outlet 13 of the turbocharger 12 is directed through hose 15 to the inlet 27 of the venturi nozzle 14′ to induce a vacuum that draws hydrocarbon vapors from canister 18′ through hose 17, through the electronically operated purge valve 18′, through the outlet 29 of the venturi nozzle 14′, through hose 19 to the inlet 21 of the turbocharger 12, through the throttle 20 and the intake manifold 22, for purging at the internal combustion engine 25. The canister 16 and thus the fuel tank are protected from manifold pressure by use of the check valve 22′.

When the turbocharger 12 is at idle, manifold vacuum draws hydrocarbon vapors from the canister 16 through the purge valve 18′, through hose 23 to the intake manifold 22, to be purged in the engine 25. The check valve 24′ prevents the manifold vacuum pressure from communicating with the venturi nozzle 14.

To reduce under-hood packaging space, an axis D of the inlet 28 of the purge valve 18′ is substantially parallel with the axis E of the outlet 30 of the purge valve 18′ and with the axis F of the venturi nozzle 14′. The use of the turbo purge module 26 reduces cost for hoses and mounting brackets since fewer of these components are required, reduces the number of connections in the system 10′, which reduces the potential leakage points, and reduces flow variability since the module 26 is consistent from application to application.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An evaporative emission management system for a vehicle comprising:
a vapor collection canister constructed and arranged to be connected with a fuel tank to receive hydrocarbon vapors from the fuel tank,
an intake manifold for drawing air into an internal combustion engine of the vehicle,
a turbocharger connected with the intake manifold to provide pressurized air to the engine, and
a single, integral turbo purge module comprising:
a purge valve having an inlet connected to the canister and an outlet connected to the intake manifold,
a venturi nozzle constructed and arranged to receive pressurized air from the turbocharger, when the turbocharger is operating, to create a vacuum to draw vapors from the canister through the purge valve to an inlet of the turbocharger and the intake manifold to be purged in the engine,
a first check valve to prevent pressure from the intake manifold from reaching the canister when the turbocharger is operating, and
a second check valve to prevent vacuum pressure from the intake manifold from communicating with the venturi nozzle when the turbocharger is at idle, with vapor from the canister being drawn through the purge valve and the intake manifold to be purged in the engine.

2. The system of claim 1, wherein the purge valve is coupled directly with the each of the first and second check valves and the venturi nozzle is coupled directly with the second check valve, without the use of flexible hoses.

3. The system of claim 1, wherein an axis of the inlet of the purge valve, an axis of the outlet of the purge valve, and an axis of the venturi nozzle are each in substantially parallel relation.

4. The system of claim 2, further comprising:
a first hose connecting the inlet of the purge valve with the canister,
a second hose connecting the outlet of the purge valve with the intake manifold,
a third hose connecting an outlet of the turbocharger with an inlet of the venturi nozzle, and
a fourth hose connecting an outlet of the venturi nozzle with the inlet of the turbocharger.

5. A turbo purge module for an emission management system of a turbocharged vehicle, the vehicle having a vapor collection canister constructed and arranged to be connected with a fuel tank to receive hydrocarbon vapors from the fuel tank, an intake manifold for drawing air into an internal combustion engine of the vehicle, and a turbocharger connected with the intake manifold to provide pressurized air to the engine, the module comprising:
a purge valve having an inlet constructed and arranged to be connected to the vapor collection canister, and an outlet constructed and arranged to be connected to the intake manifold,
a venturi nozzle constructed and arranged to receive pressurized air from the turbocharger, when the turbocharger is operating, to create a vacuum to draw vapors from the canister through the purge valve to an inlet of the turbocharger and the intake manifold to be purged in the engine,
a first check valve to prevent pressure from the intake manifold from reaching the canister when the turbocharger is operating, and
a second check valve to prevent vacuum pressure from the intake manifold from communicating with the venturi nozzle when the turbocharger is at idle, with vapor from the canister being drawn through the purge valve and the intake manifold to be purged in the engine,
wherein the purge valve, venturi nozzle, first check valve, and second check valve are integrated into a single component.

6. The module of claim 5, wherein the purge valve is coupled directly with the each of the first and second check valves and the venturi nozzle is coupled directly with the second check valve, without the use of flexible hoses.

7. The module of claim 5, wherein an axis of the inlet of the purge valve, an axis of the outlet of the purge valve, and an axis of the venturi nozzle are each in substantially parallel relation.

8. A method of providing an evaporative emission management system for a vehicle, the vehicle having a vapor collection canister constructed and arranged to be connected with a fuel tank to receive hydrocarbon vapors from the fuel tank, an intake manifold for drawing air into an internal combustion engine of the vehicle, and a turbocharger connected with the intake manifold to provide pressurized air to the engine, the method comprising the steps of:
providing a purge valve having an inlet constructed and arranged to be connected to the vapor collection canister, and an outlet constructed and arranged to be connected to the intake manifold; a venturi nozzle constructed and arranged to receive pressurized air from the turbocharger, when the turbocharger is operating, to create a vacuum to draw vapors from the canister through the purge valve to an inlet of the turbocharger and the intake manifold to be purged in the engine; a first check valve to prevent pressure from the intake manifold from reaching the canister when the turbocharger is operating; and a second check valve to prevent vacuum pressure from the intake manifold from communicating with the venturi nozzle when the turbocharger is at idle, with vapor from the canister being drawn through the purge valve and the intake manifold to be purged in the engine, and
integrating the purge valve, the venturi nozzle, the first check valve, and the second check valve into a single component.

9. The method of claim 8, wherein the integrating step includes coupling the purge valve directly with the each of the first and second check valves and coupling the venturi nozzle directly with the second check valve, without the use of flexible hoses.

10. The method of claim 8, wherein the integrating step includes ensuring that an axis of the inlet of the purge valve, an axis of the outlet of the purge valve, and an axis of the venturi nozzle are each in substantially parallel relation.
